(19) United States
(12) Patent Application Publication
(10) Pub. No.: US 2005/0256306 A1
(43) Pub. Date: Nov. 17, 2005

(54) Oxidized reversibly swelling granular starch products

(76) Inventors: Kyungsoo Woo, Platte City, MO (US); Sukh Bassi, Atchison, KS (US); Clodualdo C. Maningat, Platte City, MO (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/843,494

(22) Filed: May 11, 2004

(51) Int. Cl. C08B 33/00

(52) U.S. Cl. 536/105

(57) ABSTRACT

A rapidly-hydratable oxidized resistant starch having a cold-water hydration at least 20% greater than the resistant starch before oxidation, makeable by oxidation with an oxidizing agent selected from the group consisting of periodate, chromic acid, permanganate, nitrogen dioxide, and alkali metal hypochlorites. The starch may be made by a process for preparing a rapidly-hydratable resistant starch comprising the steps of swelling starch granules in the presence of alkali and/or heat, dispersing at least one cross-linking agent, mixing said dispersion, adding an oxidizing agent to said dispersion, and agitating said dispersion.

### BACKGROUND OF THE INVENTION

1. Field of the Invention

The present invention relates generally to resistant starch products that tend to resist digestion in the small intestine. More particularly, the present invention relates to oxidized reversibly-swellable starch products having improved hydrophilic properties and methods of preparing those products. The starch products generally are in the form of individual, chemically cross-linked starch granules that are, among other things, capable of extremely rapid hydration in hot or cold water and further capable of forming exceptionally stable emulsions.

2. Description of the Related Art

Granular cold water swelling starches are well known. These starches can be prepared by suspending wet native starch granules in rapidly moving hot air and subsequently decreasing humidity (U.S. Pat. No. 4,280,851). Alternatively, they can be prepared by heating starch in an excess of water/alcohol with subsequent removal of liquid (U.S. Pat. No. 4,465,704).

When known granular cold water swelling starches are placed in hot or cold water, the granules swell excessively and release starch solubles into the aqueous phase. Upon drying, the individual swollen starch granules collapse and fuse together. Fused granules can be reground, but do not thereafter thicken efficiently and produce a dull taste in food products.

As a consequences of these properties, typical cold water swelling starches have only limited utility in food systems where gelling is to be avoided, e.g., in broths or other watery foods. In such watery systems, the conventional starches swell and gelatinize and release amylose, and upon storage give the food an unappealing texture. In addition, the fact that the known starches are not reversibly swellable (i.e., they are incapable of undergoing successive swelling/drying cycles) limits the utility of conventional starches.

Another factor important in food grade starch relates to the in vivo digestive properties thereof. Starch serves as a food reserve in plants, and it is an important component in the human diet. The digestion of starch is mediated by salivary and pancreatic .alpha.-amylase, which catalyze the formation of maltose, maltotriose and dextrins. The latter products are further hydrolyzed to D-glucose in the brush border of the small intestines. alpha-Amylases (MW 50,000-60,000 Daltons) are endo-acting enzymes that catalyze the hydrolysis of the alpha-1,4 bonds in the amylose and amylopectin molecules that comprise starch; they do not hydrolyze the alpha-1,6-bonds but can by-pass them. Glucoamylase and alpha-glucosidase are exo-acting enzymes that cleave both alpha-1,4 and alpha-1,6 linkages of starch.

In the early 1980's it became apparent that some starch resists digestion. Instead, it enters the colon where it is fermented by bacteria. The resistance of starch to digestion in the upper GI tract is recognized to depend on intrinsic factors, which include the physical state of a food and its preparation and storage, and on extrinsic factors, which are the physiological conditions influencing starch digestion. Starch entering the colon exerts a number of different physiological effects (see below) compared to just one in the upper gastrointestinal tract, namely production of D-glucose to provide energy.

In 1987 Englyst and Cummings at the MRC Dunn Clinical Nutrition Center in Cambridge, UK, proposed a classification of starch based on its likely digestive properties in vivo. They also devised in vitro assay methods to mimic the various digestive properties of starch. Three classes of dietary starch were proposed:
(1) Rapidly Digestible Starch (RDS). RDS is likely to be rapidly digested in the human small intestine; examples include freshly cooked rice and potato, and some instant breakfast cereals.
(2) Slowly Digestible Starch (SDS). SDS is likely to be slowly yet completely digested in the small intestine; examples include raw cereal starch and cooked pasta.
(3) Resistant Starch (RS). RS is likely to resist digestion in the small intestine.

RS is thus defined as the sum of starch and starch degradation products not likely to be absorbed in the small intestine of healthy individuals. RS can be subdivided into four categories depending on the causes of resistance (Englyst et al 1992; Eerlingen et al 1993).

RS.sub.1. Physically inaccessible starch due to entrapment of granules within a protein matrix or within a plant cell wall, such as in partially milled grain or legumes after cooling.

RS.sub.2. Raw starch granules, such as those from potato or green banana, that resist digestion by .alpha.-amylase, possibly because those granules lack micropores through their surface.

RS.sub.3. Retrograded amylose formed by heat/moisture treatment of starch or starch foods, such as occurs in cooked/cooled potato and corn flake.

RS.sub.4. Chemically modified starches, such as acetylated, hydroxypropylated, or cross-linked starches that resist digestion by alpha-amylase. Those modified starches would be detected by the in vitro assay of RS. However, some RS.sub.4 may not be fermented in the colon.

RS.sub.1, RS.sub.2, RS.sub.3 are physically modified forms of starch and become accessible to .alpha.-amylase digestion upon solubilization in sodium hydroxide or dimethyl sulfoxide. RS.sub.4 is chemically modified and remains resistant to .alpha.-amylase digestion even if dissolved.

RS is of increasing interest as a food ingredient. Unlike common dietary fiber sources, RS does not hold much water and, thus may be a preferred fiber source for use in low moisture products such as cookies and crackers. Also, RS is free of a gritty mouthfeel, and unlike traditional fiber sources does not significantly alter flavor and textural properties of foods. Those characteristics can improve the processing and quality of foods such as baked and extruded products when RS is added. Furthermore, RS constitutes dietary fiber, and may be assigned zero calories.

RS is counted with the dietary fiber fraction of food and is believed to function as fiber in the human digestive tract. The reduced bioavailability of RS in the human gastrointestinal tract has significant physiological effects, such as slow glucose release and a lower postprandial glycemic response with lower blood lipids. When RS reaches the colon it is fermented to hydrogen, methane, carbon dioxide, lactic acid (transient), and short chain fatty acids (acetate, propionate, and butyrate)with purported beneficial effects that suggest prevention of colonic diseases.

It is known that the digestibility of starches can be affected by processing and storage conditions. Chemical modification of starches has been shown to inhibit their in vitro digestibility, with the extent of inhibition related to the degree of modification and presumably the type of modification. The variation depends on the botanical origin of the starch, the modifying agent(s) used and the subsequent chemical bonds and derivatives formed, the extent of granule gelatinization, and choice of enzyme (Anonymous 1972, Filer 1971). Banks et al (1973) demonstrated that the degree of substitution determined the rate and extent of amylolytic attack on hydroxyethyl amylose.

Leegwater and Luten (1971) reported an exponential decrease in the digestibility of hydroxypropyl substituted starches by pancreatin with an increasing degree of substitution up to 0.45% HP. Janzen (1969) reported that potato starch phosphate cross-linked with 0.05 and 0.1% POCI.sub.3 has no influence on the in vitro digestion with pancreatin as determined by the weight of residue after digestion. Modification with 0.5 and 1.5% POCI.sub.3, however, inhibits the hydrolysis considerably.

Hood and Arneson (1976) have reported that hydroxypropyl distarchphosphate modification increases the digestion of ungelatinized starch but decreases the digestion of gelatinized starch. Introduction of cross-links tends to stabilize granule structure and restrict the degree of swelling. With a high degree of cross-linking the porosity of the gel phase of a granule will be too fine to admit large molecules. Some reports have indicated that phosphate cross-linking slightly reduces enzymatic hydrolysis or has no effect on hydrolysis when compared to the unmodified starch (Anonymous 1972, Ostergard, 1988; Bjorck et al., 1988). Changes in the intestinal microflora of rats eating hydroxypropyl distarch phosphate, hydroxypropyl starch, and distarch phosphate suggest that starches containing ether linkages are more difficult to digest than those containing only phosphate linkages (Hood, 1976). A hydroxypropyl distarch phosphate derivative of potato starch exhibits 50% in vivo digestibility in rat (Bjorck et al., 1988).

In view of the known health benefits of dietary fibers in general, and the potentially advantageous additional properties of RS.sub.4 starches in food products, there is a need in the art for improved RS.sub.4 starches having a high degree of resistance to .alpha.-amylase digestion, as well as low-cost methods of producing such chemically modified starches.

RS4 can be produced by cross-linking and resists dissolution in most solvents. U.S. Pat. No. 6,299,907 describes improved resistant starches (RS4) which are modified so as to reversibly swell. The starches have a number of novel properties, including the ability to undergo multiple cycles of swelling and drying while substantially retaining the individuality of starch granules and leaching minimal amounts of starch solubles. These products are also capable of absorbing water in excess of their own weight.

The preparation of modified starches via oxidation of starch compounds is well known. Oxidized starch products are useful in many industries, such as paper, textile, laundry, building, and food. For example, in the paper industry starches act as fillers, fiber retainers and coatings.

Oxidation generally produces starch products with low viscosity, high stability, high clarity, and improved binding and film forming properties. Oxidized starch granules tend to swell at lower temperatures and to a greater extent than untreated starch granules. The preparation of oxidized starch is commonly carried out under strict conditions of pH, temperature, time, and concentration of oxidizing agent and salt. Various oxidizing agents, including periodate, chromic acid, permanganate, nitrogen dioxide, and sodium hypochlorite have been used. For economic reasons, alkali metal hypochlorites are preferred oxidation reagents.

The main factors controlling the type and degree of oxidation are the amount of alkali metal hypochlorite used, pH, temperature, presence of metal or bromide ions as catalysts, solids content of the reaction, and physical state of the starch (e.g., botanical origin, integrity of granular structure). Hypochlorite oxidation is markedly influenced by pH; aldehyde, ketone, and carboxyl groups form predominantly at low, neutral, and high pH, respectively. The rate of reaction is very high near neutral pH and very slow above pH 11.0 when employing most cereal (e.g., corn, wheat, waxy corn) starches. The reaction rate of hypochlorite oxidation tends to increase 2-4 times with every 10° C. increase in temperature. The presence of bromide or cobalt ions exerts a catalytic effect at alkaline pH. Nickel sulfate was also shown to have a catalytic effect on hypochlorite oxidation.

The oxidation of starch by an oxidizing agent such as sodium hypochlorite is described by Rutenberg (Starch Chemistry and Technology; 2nd ed. pp. 315-323 (1984)) and Wurzberg (Modified Starches: Properties and Uses, pp. 23-29 (1986)). During the oxidation reaction, hydroxyl groups on starch molecules are first oxidized to carbonyl groups and then to carboxyl groups. The number of carboxyl and carbonyl groups on modified starch indicate the level of oxidation, which takes place primarily at the hydroxyl groups of C-2, C-3, and C-6 positions, as depicted in FIG. 1.

Oxidized starch granules tend to swell at lower temperatures and swell to a greater extent than untreated starch granules. Prior art oxidized starch products tend to swell excessively and fuse together upon dispersion in water and heating above the granule melting or gelatinization temperature. After cooking, these products do not retain a granular structure but rather agglomerate to form a paste-like system.

### SUMMARY

The present invention provides starch products that have improved water affinity over starch products of the prior art and that rapidly hydrate in hot or cold water and form stable emulsions. Starch products of the present invention comprise natural or initially-modified starch granules that are initially pre-swelled and chemically cross-linked and thereafter oxidized to form hydrophilic moieties on the granular starch structure. Virtually any starch can be modified in accordance with the invention, although relatively inexpensive starches such as wheat and corn starches are preferred. The starch in this invention may be previously modified by the hydrolytic action of acid and/or heat and/or enzymes.

In summary, the inventions disclosed and claimed by applicant include the following modified starch compositions and processes for making modified starch compositions:
1. A rapidly-hydratable oxidized resistant starch having a cold-water hydration at least 20% greater than the resistant starch before oxidation.
2. A rapidly-hydratable oxidized resistant starch having a cold-water hydration at least 100% greater than the resistant starch before oxidation.
3. A rapidly-hydratable oxidized resistant starch having a hot-water hydration at least 20% greater than the resistant starch before oxidation.
4. A rapidly-hydratable oxidized resistant starch having a hot-water hydration at least 120% greater than the resistant starch before oxidation.
5. A rapidly-hydratable oxidized resistant starch having a water/starch emulsion stability at least 20% greater than the resistant starch before oxidation.
6. A rapidly-hydratable oxidized resistant starch having a cold-water hydration at least 20% greater than the resistant starch before oxidation and a hot-water hydration at least 20% greater than the resistant starch before oxidation.
7. A rapidly-hydratable oxidized resistant starch having a cold-water hydration at least 20% greater than the resistant starch before oxidation, a hot-water hydration at least 20% greater than the resistant starch before oxidation, and a water/starch emulsion stability at least 20% greater than the resistant starch before oxidation.
8 A process for preparing a rapidly-hydratable resistant starch comprising the steps of swelling starch granules in the presence of alkali and/or heat, dispersing at least one cross-linking agent, mixing the dispersion, adding an oxidizing agent to the dispersion, and agitating the dispersion.
9. A process for preparing a rapidly-hydratable resistant starch comprising the steps of preparing an aqueous dispersion of at least one cross-linked resistant starch, mixing the dispersion at a temperature from about 10° C. to about 50° C. (80° C. in the case of high-amylase starches) adding an oxidizing agent to the dispersion in an amount from about 0.1% to about 50% by weight (based on total weight of the starch taken as 50% by weight)at a pH from about 7 to about 12, and agitating for a period ranging from about 1 to about 24 hours.

The modified starches of this invention exhibit remarkable properties. For example, the modified starch is capable of absorbing or adsorbing hot and cold water in far greater quantities than conventional cross-linked resistant starches, and without undue agglomeration or clumping during the hydration or dehydration processes. In addition, the starches readily disperse in cold or hot water or oil/water mixtures without extensive agitation. The highly hydrophilic moieties provided by oxidation render the starch suitable for use as a thickening, stabilizing and/or suspending agent or as a vector for the delivery of biologically active ingredients. The oxidized starch products have increased stability when used with other polymers such as hydrocolloids or proteins in products such as foods, cosmetics and pharmaceuticals.

### DESCRIPTION OF DRAWINGS

FIG. 1 depicts a cross-linked oxidized starch molecule.

FIG. 2 depicts a prior-art process for creating starch granules that are expanded or pre-swollen and chemically cross-linked.

FIG. 3 depicts a process for oxidizing the starch granules of FIG. 1

FIG. 4 depicts a process for preparing cross-linked oxidized starch granules FIG. 5 depicts a reproduction of pre-swollen, cross-linked starch granules in the process of being oxidized after 1 hours of reaction time.

FIG. 6 depicts a reproduction of pre-swollen, cross-linked starch granules in the process of being oxidized after 2 hours of reaction time.

FIG. 7 depicts a reproduction of pre-swollen, cross-linked starch granules in the process of being oxidized after 4 hours of reaction time.

FIG. 8 depicts a reproduction of pre-swollen, cross-linked starch granules in the process of being oxidized after 16 hours of reaction time.

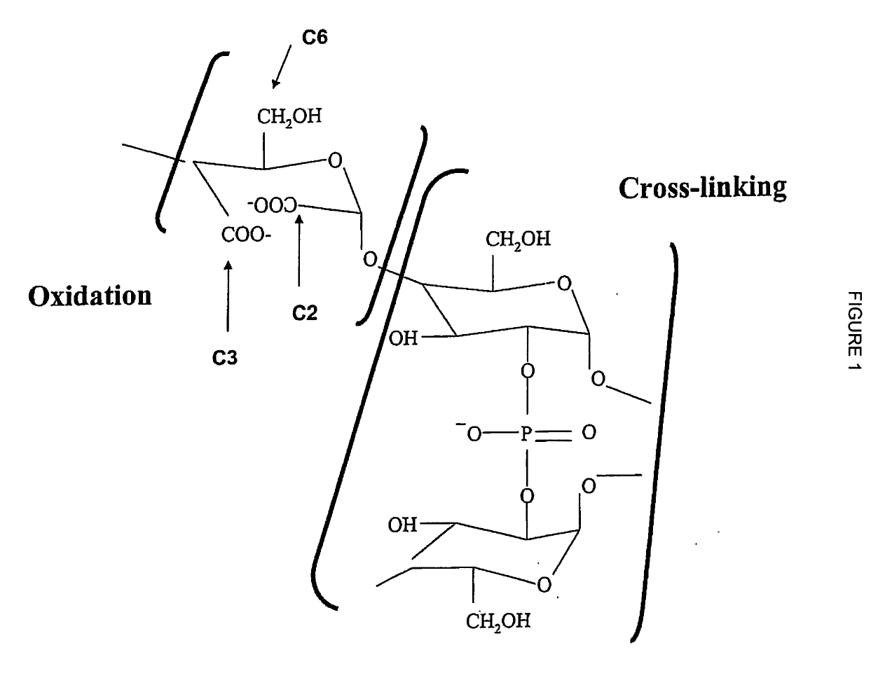

### DESCRIPTION OF EMBODIMENTS

The drawings and following examples form part of the specification. The drawings and examples are for exemplary purposes only and are not intended to limit the invention as defined by the claims. One of skill in the art will recognize that various modifications and substitutions may be made to the embodiments herein described and still the result will fall within the spirit and scope of the claimed invention.

The starch products of this invention are characterized by extremely rapid hydration in hot or cold water and stabilization in aqueous environments. Broadly speaking, the starch products of the invention are prepared in the form of individual starch granules which are expanded or pre-swollen and chemically cross-linked. The products are then oxidized to convert hydroxyl groups of starch to more hydrophilic carbonyl and carboxyl groups. To enhance the formation of negatively charged starchate ions, oxidation of the starch product is achieved under alkaline conditions, above pH 8.0.

It has been found that the preferred starches of this invention exhibit higher water affinities, at least 10% more than products without oxidation. Moreover, these preferred starches exhibit those characteristics over extended storage at room temperature, for example at least about 15 days and usually for at least about 30 days.

The ease of mixing and increased swelling of the compositions of the present invention possibly may be explained in the following manner: (1) the hydrophilic carbonyl and carboxyl groups attract more water into the internal void space of the granules when the starch is placed in an aqueous solution; and (2) converting hydroxyl groups of starch into electrically repulsive carboxyl groups reduces hydrogen bonding between starch granules.

A variety of different starches can be modified in accordance with the invention, and indeed essentially any starch can be modified as described herein. Starches for modification may be natural or modified, with the modified starches including substituted or converted starches (examples being hydroxyprophylation and/or hydrolysis by acids or enzymes). Useful starches include cereal, root, tuber, legume and high amylose starches. Preferably, however, the starches are selected from the group consisting of wheat, waxy wheat, corn, waxy corn, high amylose corn, oat, rice, tapioca, mung bean, potato starches and mixtures thereof.

The starches useful in the invention can be chemically cross-linked in a number of ways using an assortment of different cross-liking agents, such as those selected from the group consisting of sodium trimetaphosphate (STMP), sodium tripolyphosphate, phosphoryl chloride, epichlorohydrin and mixtures thereof. It is particularly preferred that the cross-linking reaction be carried out by swelling the starch granules in the presence of an alkali (e.g., alkali metal hydroxide) and/or heat and salt (e.g., alkali or alkaline earth metal chloride, sulfate or carbonate). The alkali base is present to promote swelling of starch, whereas the salt is added to prevent excess swelling that may lead to complete destruction of the granular structure of the starchate salt (i.e., gelatinization). Preferred pre-swelling/cross-linking conditions and parameters are set forth in U.S. Pat. No. 6,299,907 which is expressly incorporated herein by reference.

In more detail, the most preferred initial cross-linking reaction involves a process of first forming a dispersion of starch granules in water where the granules undergo swelling in the dispersion and have a crystalline phase. A cross-linking agent is added to the dispersion while the granules are swelled in order to cross-link the swelled granules, the cross-linking being carried out under conditions such as those described above to avoid complete gelatinization of the swelled granules. Thereafter, the cross-linked starch granules are heated in excess water in order to melt the crystalline phase of the granules.

In a preferred procedure, the starch granules are pre-swelled by first forming a starch/water dispersion and heating the dispersion to swell the granules prior to the addition of the cross-linking agent; the pre-swelling step is preferably carried out in the presence of a base (such as alkali metal hydroxide which promotes swelling) and a salt (such as alkali or alkaline earth metal chloride, sulfate or carbonate).

Again, it is important that the pre-swelling and cross-linking step be carried out so as to avoid complete gelatinization of starch granules. Accordingly, the temperature of the starch dispersion during pre-swelling is generally 5-10° C. below the starch gelatinization temperature. It is also possible to pre-swell the starch at elevated temperatures, for example 70-80° C. if high concentrations (greater than 20% based on starch) of salt are used with reduced amounts of base. The alkali metal hydroxide is normally present at a level of 1-3% by weight based upon starch, while the salt is used at a level of from about 5-25% by weight on the same basis. The pH of the pre-swelling system is generally from about 10-12.

During the cross-linking step, the dispersion should have from about 10-40% by weight of starch solid therein. The cross-linking step generally involves heating to a temperature of from about 30-75° C. for a period from about 0.1-24 hours, more preferably from about 0.5-16 hours. When the preferred STMP cross-linking agent is used, it is typically present in from 2-12% by weight on a dry starch basis.

During cross-linking, if an inadequate level of STMP is employed, the starch will eventually gelatinize due to swelling. When this occurs, swelling has not been counterbalanced by sufficient cross-linking. Increasing the temperature of the reaction mixture results in accelerating both the swelling and the cross-linking reactions, such that gelatinization of the reaction mixture due to swelling occurs before sufficient cross-linking is possible. After reacting at an appropriate temperature for several hours, the mixture is neutralized and the starch is isolated from the salt to yield quantitative products. The product exhibits an elevated gelatinization temperature and decreased enthalpy of gelatinization as compared with the parent starch.

Pre-swollen/cross-linked starches are subjected to an oxidation reaction, typically after the cross-linking reaction and prior to gelatinization. Oxidation produces hydrophilic carboxyl and carbonyl groups on the starch product. The preferred oxidation reaction is carried out in an aqueous solvent system, using sodium hypochlorite. The oxidizing agent is used at a level of from about 0. 1-50% by weight, based on total weight of the starch taken as 100% by weight, more preferably from 1-30%, and most preferably from 2-15% by weight.

The oxidation reaction is usually carried out at a pH of 7-12, more preferably from about 10-11. The temperature should be from about 10-50° C. and more preferable 30-45° C. When high-amylase starch is used, the temperature may preferably be in the range of 30-80° C. Reaction times are variable depending upon the degree of oxidation desired, but generally range from 1-24 hours, more preferably 1-8 hours. It is normally preferred that the oxidation reaction be conducted with continuous agitation. At the end of the reaction, the reaction mixture may be neutralized with acid to pH about 5-7, more preferably about pH 6. Thereafter the starch products may be washed with water to remove inorganic salts.

Optionally, the partially crystalline, oxidized swollen/cross-linked starches may be heated in excess water at a temperature of from about 50 to 150° C., more preferably from about 70-95° C. For example, a 10% aqueous slurry of partially crystalline product may be heated to boiling with stirring for about 10 minutes to achieve gelatinization.

The final step involves recovery and drying of the modified starches, which is preferably accomplished by spray drying. The liquid fraction contains at most 1-2% of the original weight of partially crystalline modified starch in the form of a gelatinized starch. If the starch is merely dried on a tray without removal of the soluble and damaged starch fraction, the product may form a cake-like structure comprised of granules that cling together. Spray drying, however, forms a homogenous, fine powder.

### EXAMPLE 1

(a) Preparation of Pre-Swelled/Cross-Linked Starch

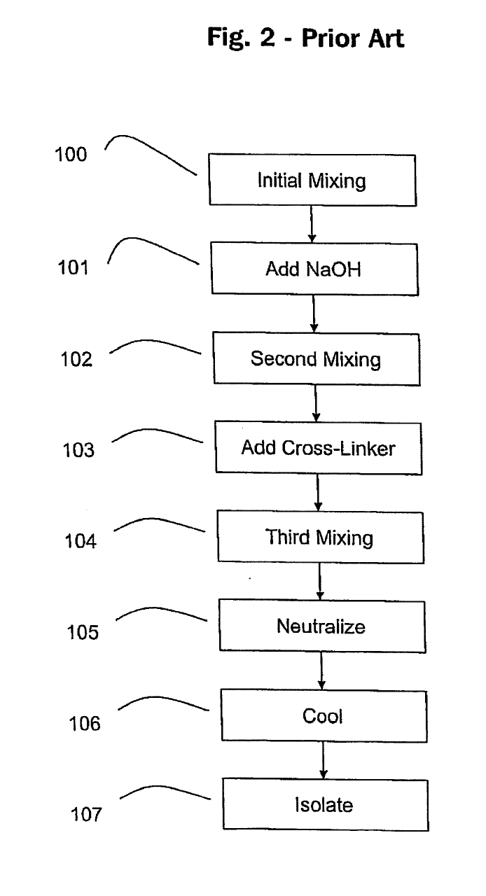

This example, as depicted in the flowchart of FIG. 2, describes the production of oxidized starch from granular pre-swollen/cross-linked wheat starch. In step 100, wheat starch (100 parts, dry basis) was dispersed in 233 parts of water with 2 parts of sodium sulfate and mixed. After mixing for 30 minutes, sodium hydroxide (1.5 parts) was added in step 101. The reaction mixture was heated to 45° C. and continuously mixed at that temperature for 2 hours in step 102. For efficient cross-linking, 3.8 parts of sodium trimetaphosphate, 0.038 parts of sodium polyphosphate and 3 parts of sodium sulfate were added together in step 103. After further mixing for 20 hours at 45° C. in step 104, the slurry was neutralized to pH 6.5 with dilute 1.0 N hydrochloric acid in step 105 and cooled to 25° C. in step 106. Starch was isolated by washing with water and spray drying in step 107.

(b) Preparation of Oxidized Pre-Swelled/Cross-Linked Starch

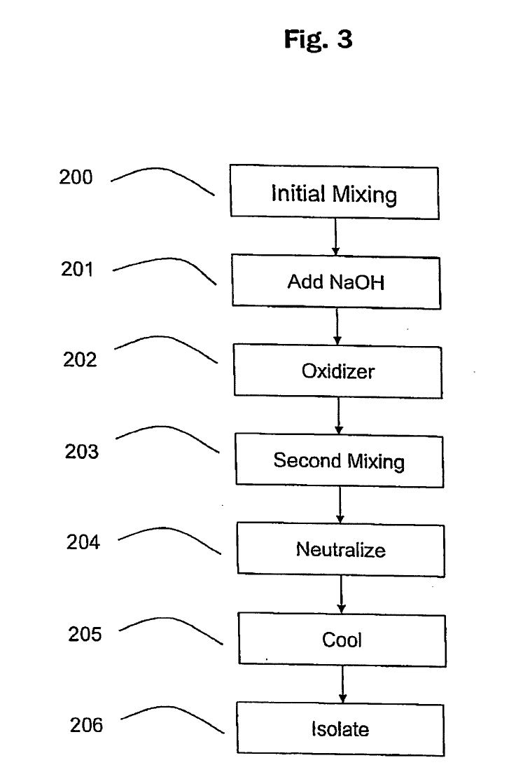

This phase of the synthesis is illustrated in the flowchart of FIG. 3. In step 200, pre-swollen/cross-linked starch, prepared as described above, (300 parts, dry basis) was dispersed in 700 parts of water and mixed for 30 minutes. In step 201, the dispersion was warmed to 45° C. and pH was adjusted to 11.0 with 1 M sodium hydroxide. Sodium hypochlorite 7.5% (dry starch basis) was added to the slurry in step 202 and continuously stirred for 16 hours at 45° C. in step 203. In step 204, the slurry was adjusted to pH 6.0 with 1.0 N hydrochloric acid and then, in step 205, cooled to room temperature (25° C.). In step 206, the ungelatinized starch was washed with water to remove inorganic salts and recovered by spray drying.

(c) Testing

The final product was tested by cold water and hot water hydration tests. In the cold water hydration test, 5 g of starch was dispersed in 100ml of distilled water at room temperature (approximately 25° C.) in a 250 ml beaker (e.g. Corning Pyrex beaker #1000-250) and then stirred continuously for 30 minutes. The starch/water mixture was then transferred to a 100 ml. graduated cylinder (e.g. Corning Pyrex beaker #3062-100) and the swollen volume of the entire contents of the cylinder was measured after sitting for 24 hours at room temperature (approximately 25° C.). A swollen volume ratio for the cold water dispersion was determined by measuring the swollen volume (in milliliters) of the contents of the graduated cylinder and dividing this by the dry weight of the starch (in grams).

In the hot water hydration test, 5 g of starch was dispersed in 100 ml of distilled water at room temperature (approximately 25° C.) in a 250 ml beaker (e.g. Corning Pyrex beaker #1000-250) and then heated to 85° C. and stirred continuously for 30 minutes. The starch/water mixture was then transferred to a 100 ml. graduated cylinder (e.g. Corning Pyrex beaker #3062-100) and the swollen volume of the entire contents of the cylinder was measured after sitting for 24 hours at room temperature (approximately 25° C.). A swollen volume ratio for the cold water dispersion was determined by measuring the swollen volume (in milliliters) of the contents of the graduated cylinder and dividing this by the dry weight of the starch (in grams).

An emulsion stability test also was performed. 5 g of oxidized starch was dispersed in 100 ml of a 1:1 mixture of distilled water and vegetable oil (e.g., soybean oil, in this experiment Crisco, J. M. Smucker Company, Orrville, Ohio), at room temperature (approximately 25° C.) in a 250 ml beaker (e.g. Corning Pyrex beaker #1000-250) and then heated to 85° C. and stirred continuously for 30 minutes. The starch/oil/water mixture was then transferred to a 100 ml. graduated cylinder (e.g. Corning Pyrex beaker #3062-100). The water/oil/starch dispersion was white in color and had a creamy appearance at 85° C. The dispersion was then allowed to sit for 24 hours at room temperature (approximately 25° C.). Three fractions formed: a water/starch fraction, a water fraction and a starch/oil fraction (listed from the bottom up in the cylinder). After the 24 hours, the swollen volume of each of the three fraction in the cylinder was measured. Swollen volume ratios for each of the three fractions was determined by measuring the swollen volume (in milliliters) of a fraction and dividing this by the dry weight of the starch (in grams).

### EXAMPLE 2

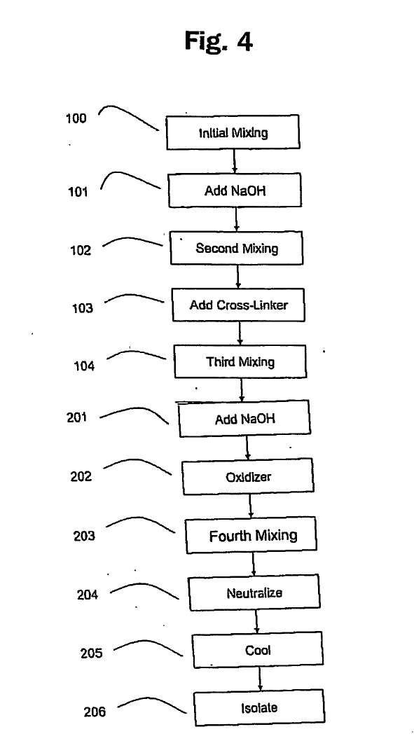

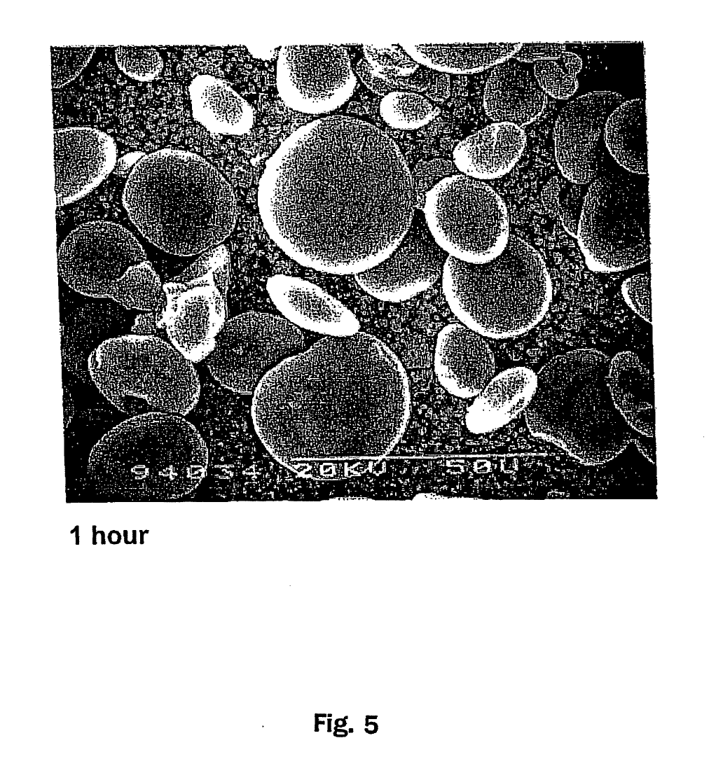

Example 1 describes a two-step process for producing a starch of the invention. Alternatively, the two steps may be combined to produce a starch of the invention in a one-step embodiment, whether batch, semi-continuous or continuous. An example of such a process is depicted in the process flowchart of FIG. 4.

In step 100, wheat starch (100 parts, dry basis) is dispersed in 233 parts of water with 2 parts of sodium sulfate and mixed. After mixing for 30 minutes, sodium hydroxide (1.5 parts) are added in step 101. The reaction mixture is heated to 45° C. and continuously mixed at that temperature for 2 hours in step 102. For efficient cross-linking, 3.8 parts of sodium trimetaphosphate, 0.038 parts of sodium polyphosphate and 3 parts of sodium sulfate are added together in step 103. There is further mixing for 20 hours at 45° C. in step 104.

Thereafter, in step 201, pH is adjusted to 11.0 with 1 M sodium hydroxide. Sodium hypochlorite 7.5% (dry starch basis) is added to the slurry in step 202 and continuously stirred for 16 hours at 45° C. in step 203. In step 204, the slurry is adjusted to pH 6.0 with 1.0 N hydrochloric acid and then, in step 205, cooled to room temperature (25° C.). In step 206, the ungelatinized starch is washed with water to remove inorganic salts and recovered by drying in an oven at 40° C.

### EXAMPLE 3

In this example a series of oxidized wheat starch products were made using a constant level of 7.5% (w/w, dry basis of starch) sodium hypochlorite at pH 11 for 16 hours. Three separate experiments were carried out at temperatures of 25° C., 35° C., and 45° C. The methods described in Example 1 for the preparation of the starch products were followed, as were the tests conducted in Example 1. The three oxidized starch products are compared to the non-oxidized starch prepared in Example 1 (a) in Table 1:

TABLE 1
Swollen Volume Ratio (v/w)

| | Water Hydration Test | | Emulsion Stability Test | | |
|---|---|---|---|---|---|
| | Cold Water | Hot Water | Water/ | | |
| | (25° C.) | (85° C.) | Starch | Water | Starch/Oil |
| S RS^{a} | 1.5 | 3.8 | 5.2 | 3.6 | Negligible |
| S RS-Oxy^{b} | | | | | |
| 25° C. | 2.6 | 7.6 | 8.2 | 2.8 | Negligible |
| 35° C. | 2.3 | 7.1 | 7.8 | 2.6 | Negligible |
| 45° C. | 2.2 | 6.5 | 6.9 | 8.3 | Negligible |

^{a}SRS: Reversibly Swellable Resistant Starch
^{b}SRS-Oxy: Oxidized Reversibly Swellable Resistant Starch

### EXAMPLE 4

A series of modified wheat starch products were prepared as set forth in Example 1 oxidized with a constant level of 7.5% (w/w, dry basis of starch) sodium hypochlorite at pH 11 and 45° C. Three separate experiments were carried out at reaction times of 4 hours, 8 hours and 16 hours. The methods described in Example 1 for the preparation of the starch products were followed, as were the tests conducted in Example 1. The three oxidized starch products are compared to the non-oxidized starch prepared in Example 1 (a) in Table 2:

TABLE 2
Swollen Volume Ratio (v/w)

| | Water Hydration Test | | Emulsion Stability Test | | |
|---|---|---|---|---|---|
| | Cold Water | Hot Water | Water/ | | |
| | (25° C.) | (85° C.) | Starch | Water | Starch/Oil |
| S RS^{a} | 1.5 | 3.8 | 5.2 | 3.6 | Negligible |
| S RS-Oxy^{b} | | | | | |
| 4 h | 3.0 | 8.2 | 8.6 | 2.4 | Negligible |
| 8 h | 2.5 | 6.5 | 6.9 | 3.5 | Negligible |
| 16 h | 2.2 | 6.5 | 6.9 | 3.8 | Negligible |

^{a}SRS: Reversibly Swellable Resistant Starch
^{b}SRS-Oxy: Oxidized Reversibly Swellable Resistant Starch

### EXAMPLE 5

In this example a series of oxidized wheat starch products were made using a constant level of 7.5% (w/w, dry basis of starch) sodium hypochlorite at 45° C. for 16 hours. Three separate experiments were carried out at pH levels of 9, 10 and 11. The methods described in Example 1 for the preparation of the starch products were followed, as were the tests conducted in Example 1. The three oxidized starch products are compared to the non-oxidized starch prepared in Example 1 (a) in Table 3:

TABLE 3
Swollen Volume Ratio (v/w)

| | Water Hydration Test | | Emulsion Stability Test | | |
|---|---|---|---|---|---|
| | Cold Water | Hot Water | Water/ | | |
| | (25° C.) | (85° C.) | Starch | Water | Starch/Oil |
| S RS^{a} | 1.5 | 3.8 | 5.2 | 3.6 | Negligible |
| S RS-Oxy^{b} | | | | | |
| pH 9.0 | 1.5 | 7.5 | 7.7 | 2.6 | Negligible |
| pH 10.0 | 2.7 | 7.5 | 6.4 | 3.6 | Negligible |
| pH 11.0 | 2.2 | 6.5 | 6.9 | 3.8 | Negligible |

^{a}SRS: Reversibly Swellable Resistant Starch
^{b}SRS-Oxy: Oxidized Reversibly Swellable Resistant Starch

### EXAMPLE 6

In this example a series of oxidized wheat starch products were made using varying levels of sodium hypochlorite at 45° C., pH 11.0 for 1 6h. Three separate experiments were carried out at sodium hypochlorite concentrations of 2.5%, 5.0% and 7.5%, each w/w, dry basis of starch. The methods described in Example 1 for the preparation of the starch products were followed, as were the tests conducted in Example 1. The three oxidized starch products are compared to the non-oxidized starch prepared in Example 1 (a) in Table 4:

TABLE 4
Swollen Volume Ratio (v/w)

| | Water Hydration Test | | Emulsion Stability Test | | |
|---|---|---|---|---|---|
| | Cold Water | Hot Water | Water/ | | |
| | (25° C.) | (85° C.) | Starch | Water | Starch/Oil |
| S RS^{a} | 1.5 | 3.8 | 5.2 | 3.6 | Negligible |
| S RS-Oxy^{b} | | | | | |
| 2.5% | 2.6 | 7.2 | 6.2 | 3.8 | Negligible |
| 5.0% | 2.4 | 7.1 | 7.8 | 2.8 | Negligible |
| 7.5% | 2.2 | 6.5 | 6.9 | 3.8 | Negligible |

^{a}SRS: Reversibly Swellable Resistant Starch
^{b}SRS-Oxy: Oxidized Reversibly Swellable Resistant Starch

### EXAMPLE 7

Pre-swelled/cross-linked corn starch (300 parts, dry basis) was dispersed in 700 parts of water and mixed for 30 minutes. The dispersion was warmed to 45° C. and pH was adjusted to 11.0 with 1 M sodium hydroxide. Sodium hypochlorite 7.5% (dry starch basis) was added to the slurry with continuous stirring and the reaction temperature was maintained at 45° C. for 16 hours. After 16 hours, the pH of the slurry was adjusted to 6.0 with 1 M sodium hydroxide and then cooled to room temperature (25° C.). The ungelatinized starch was washed with water to remove inorganic salts and recovered by drying in an oven at 40° C.

After oxidation in various conditions, it was apparent that all oxidation conditions employed improved hydrophilic properties and emulsion stability, which was shown by increased swollen volumes in hot and cold water hydration tests and swollen volume increases in an emulation stability test. Typical oxidation rate increase was accomplished by elevated temperature, alkalinity, time, and level of oxidizing agent, which tend to improve hydrophilic properties and emulsion stability. In extreme conditions of oxidation, however, degradation of some of the glucosidic linkages may occur and result in partial damage to the granular structure of the starch products.

### EXAMPLE 8

FIGS. 5 through 8 show for exemplary purposes scanning electron micrographs, taken at successive time intervals, of oxidized starch particles formed according to the methods described in Example 1. Swellable resistant starch was oxidized with sodium hypochlorite 7.5% (w/w, dry starch basis) at pH 11 and 45° C. during varied reaction periods. The reference line on the micrographs represents 50 micrometers.

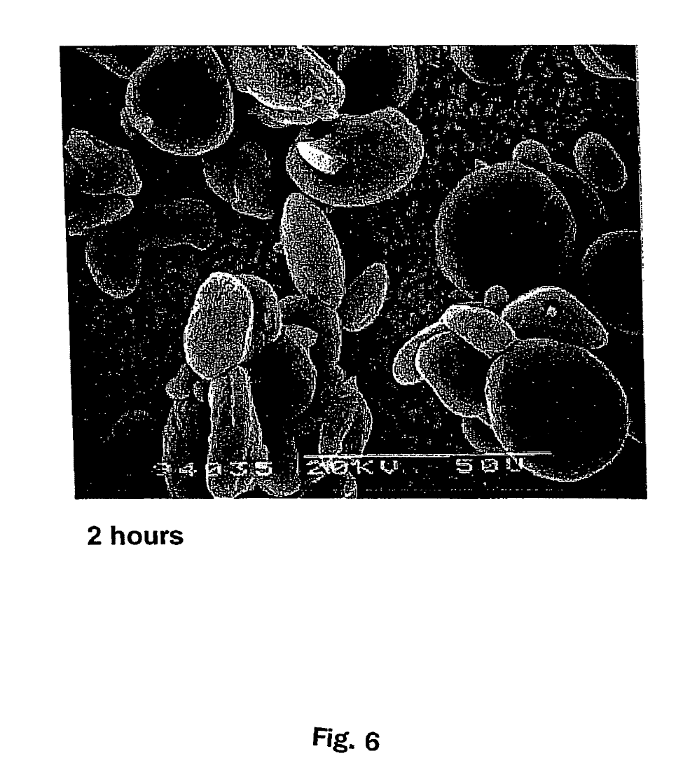

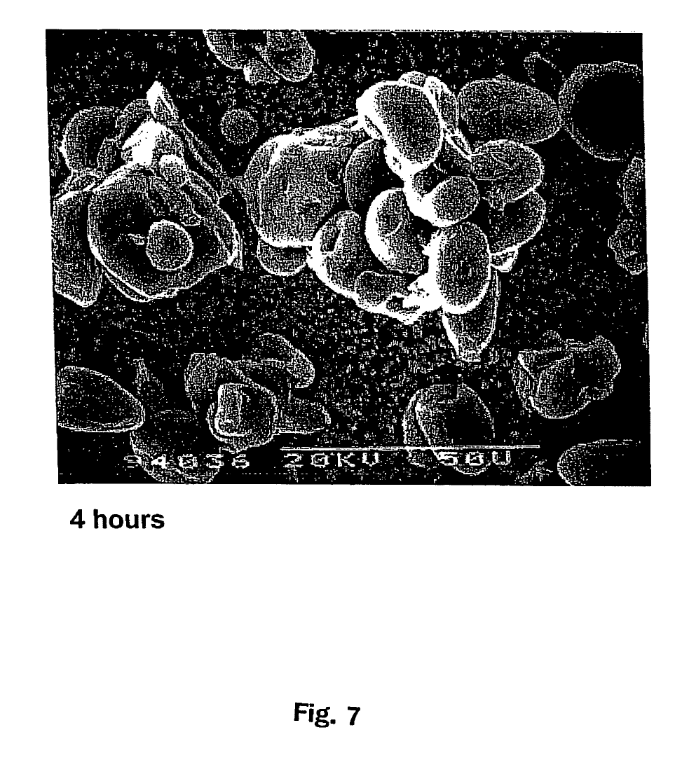

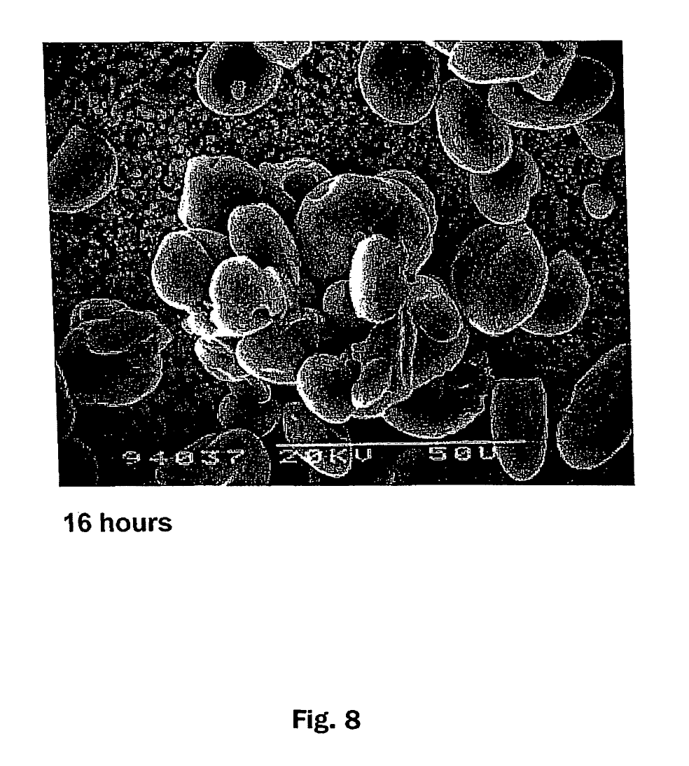

As oxidation proceed with time, surface interaction of granular starch increases and this was related to the formation of negatively charged starchate ions on the surface of starch granules. After 1 hour, as seen in FIG. 5, individually swelled particles are observed. After 2 hours, as seen in FIG. 6, the beginning stages of particle agglomeration are observed. The particles involved in agglomeration are of different sizes, and the agglomerations are made up of different numbers of these different sized particles. Further agglomeration is noted at 4 hours, as shown in FIG. 7. Negligible changes are observed between 4 hours and 16 hours, the latter being shown in FIG. 8. Oxidized reversibly swellable resistant starch showed limited swelling with high surface stickiness.

Oxidized reversibly swellable resistant starch will be useful in batters and breadings for food stuffs, which will be reconstituted by microwave heating. Conventional products generally develop unacceptable, tough and rubbery texture. Maintaining freshness of the products is regarding as highly associated with reduced swelling and homogeneous mixing of starch in protein network.

1. A rapidly-hydratable oxidized resistant starch having a cold-water hydration at least 20% greater than the resistant starch before oxidation.

2. The rapidly-hydratable starch of claim 1 made by oxidation with an oxidizing agent selected from the group consisting of periodate, chromic acid, permanganate, nitrogen dioxide, and alkali metal hypochlorites.

3. The rapidly-hydratable starch of claim 2 made by oxidation with sodium hypochlorite.

4. The rapidly-hydratable starch of claim 1 made from cross-linked starch granules.

5. The starch of claim 4, wherein said granules are cross-linked by a crosslinker selected from the group consisting of phosphorylating agents and epichlorohydrin.

6. The starch of claim 4, wherein said starch granules are modified starch granules.

7 The starch of claim 4, wherein said starch granules are selected from the group consisting of wheat, corn, waxy corn, high amylose corn, oat, rice, tapioca, mung bean and potato starches.

8. A rapidly-hydratable oxidized resistant starch having a cold-water hydration at least 100% greater than the resistant starch before oxidation.

9. The rapidly-hydratable starch of claim 8 made by oxidation.

10. The rapidly-hydratable starch of claim 9 made by oxidation with sodium hypochlorite.

11. The rapidly-hydratable starch of claim 8 made from cross-linked starch granules.

12. The starch of claim 11, wherein said granules are cross-linked by a crosslinker selected from the group consisting of phosphorylating agents and epichlorohydrin.

13. The starch of claim 11, wherein said starch granules are selected from the group consisting of cereal, root, tuber, legume and high amylose starches.

14. A rapidly-hydratable oxidized resistant starch having a hot-water hydration at least 9-20% greater than the resistant starch before oxidation.

15. A rapidly-hydratable resistant starch having a hot-water hydration in excess of 4.0.

16. The rapidly-hydratable starch of claim 15 made by oxidation with an oxidizing agent selected from the group consisting of periodate, chromic acid, permanganate, nitrogen dioxide, and alkali metal hypochlorites.

17. The rapidly-hydratable starch of claim 16 made by oxidation with sodium hypochlorite.

18. The rapidly-hydratable starch of claim 16 made from cross-linked starch granules.

19. The starch of claim 18, wherein said granules are cross-linked by a crosslinker selected from the group consisting of phosphorylating agents and epichlorohydrin.

20. The starch of claim 18, wherein said starch granules are modified starch granules.

21. The starch of claim 18, wherein said starch granules are selected from the group consisting of wheat, corn, waxy corn, high amylose corn, oat, rice, tapioca, mung bean and potato starches.

22. A rapidly-hydratable oxidized resistant starch having a hot-water hydration at least 120% greater than the resistant starch before oxidation.

23. The rapidly-hydratable starch of claim 22 made by oxidation with an oxidizing agent selected from the group consisting of periodate, chromic acid, permanganate, nitrogen dioxide, and alkali metal hypochlorites.

24. The rapidly-hydratable starch of claim 23 made by oxidation with sodium hypochlorite.

25. The rapidly-hydratable starch of claim 22 made from cross-linked starch granules.

26. The starch of claim 25, wherein said granules are cross-linked by a crosslinker selected from the group consisting of phosphorylating agents and epichlorohydrin.

27. The starch of claim 25, wherein said starch granules are modified starch granules.

28. The starch of claim 25, wherein said starch granules are selected from the group consisting of wheat, corn, waxy corn, high amylose corn, oat, rice, tapioca, mung bean and potato starches.

29. A rapidly-hydratable oxidized resistant starch having a water/starch emulsion stability at least 20% greater than the resistant starch before oxidation.

30. The rapidly-hydratable starch of claim 29 made by oxidation with an oxidizing agent selected from the group consisting of periodate, chromic acid, permanganate, nitrogen dioxide, and alkali metal hypochlorites.

31. The rapidly-hydratable starch of claim 30 made by oxidation with sodium hypochlorite.

32. The rapidly-hydratable starch of claim 29 made from cross-linked starch granules.

33. The starch of claim 32, wherein said granules are cross-linked by a crosslinker selected from the group consisting of phosphorylating agents and epichlorohydrin.

34. The starch of claim 32, wherein said starch granules are modified starch granules.

35. The starch of claim 32, wherein said starch granules are selected from the group consisting of wheat, corn, waxy corn, high amylose corn, oat, rice, tapioca, mung bean and potato starches.

36. A rapidly-hydratable oxidized resistant starch having a cold-water hydration at least 20% greater than the resistant starch before oxidation and a hot-water hydration at least 20% greater than the resistant starch before oxidation.

37. The rapidly-hydratable starch of claim 36 made by oxidation.

38. The rapidly-hydratable starch of claim 37 made by oxidation with sodium hypochlorite.

39. The rapidly-hydratable starch of claim 36 made from cross-linked starch granules.

40. The starch of claim 39, wherein said granules are cross-linked by a crosslinker selected from the group consisting of phosphorylating agents and epichlorohydrin.

41. The starch of claim 39, wherein said starch granules are modified starch granules.

42. The starch of claim 39, wherein said starch granules are selected from the group consisting of wheat, corn, waxy corn, high amylose corn, oat, rice, tapioca, mung bean and potato starches.

43. A rapidly-hydratable oxidized resistant starch having a cold-water hydration at least 20% greater than the resistant starch before oxidation, a hot-water hydration at least 20% greater than the resistant starch before oxidation, and a water/starch emulsion stability at least 20% greater than the resistant starch before oxidation.

44. The rapidly-hydratable starch of claim 43 made by oxidation with an oxidizing agent selected from the group consisting of periodate, chromic acid, permanganate, nitrogen dioxide, and alkali metal hypochlorites.

45. The rapidly-hydratable starch of claim 44 made by oxidation with sodium hypochlorite.

46. The rapidly-hydratable starch of claim 43 made from cross-linked starch granules.

47. The starch of claim 46, wherein said granules are cross-linked by a crosslinker selected from the group consisting of phosphorylating agents and epichlorohydrin.

48. The starch of claim 46, wherein said starch granules are selected from the group consisting of cereal, root, tuber, legume and high amylose starches.

49. The starch of claim 46, wherein said starch granules are selected from the group consisting of wheat, corn, waxy corn, high amylose corn, oat, rice, tapioca, mung bean and potato starches.

50. A process for preparing a rapidly-hydratable resistant starch, said process comprising the following steps:
swelling starch granules in the presence of alkali and/or heat;
dispersing at least one cross-linking agent;
mixing said dispersion;
adding an oxidizing agent to said dispersion; and
agitating said dispersion.

51. The process of claim 50 wherein said dispersion is an aqueous dispersion.

52. The process of claim 50 wherein said mixing step is carried out at a temperature from about 25° C. to about 45° C.

53. The process of claim 50 wherein the mixing step is carried out at a pH of about 7 to about 12.

54. The process of claim 50 wherein the mixing step is carried out at a pH of about 10 to about 11.

55. The process of claim 50 wherein said agitation step is carried out at a temperature from about 10° C. to about 50° C.

56. The process of claim 50 wherein said agitation step is carried out at a temperature from about 30° C. to about 45° C.

57. The process of claim 50 wherein said agitation step is maintained for a time ranging from about 1 to about 24 hours.

58. The process of claim 50 wherein said agitation step is maintained for a time ranging from about 2 to about 4 hours.

59. The process of claim 50 wherein said agitation step is carried out at a pH ranging from about 7 to about 12.

60. The process of claim 50 wherein said agitation step is carried out at a pH ranging from about 10 to about 11.

61. The process of claim 50 wherein agitation during said agitation step is continuous throughout said agitation step.

62. The process of claim 50, wherein the concentration of oxidizing agent is from about 0.1% to about 50% by weight, based on total weight of the starch taken as 50% by weight.

63. The process of claim 50, wherein the concentration of oxidizing agent is from about 1% to about 30% by weight, based on total weight of the starch taken as 50% by weight.

64. The process of claim 50, wherein the concentration of oxidizing agent is from about 2% to about 15% by weight, based on total weight of the starch taken as 50% by weight.

65. The process of claim 50 wherein said oxidizing agent is selected from the group consisting of periodate, chromic acid, permanganate, nitrogen dioxide, and alkali metal hypochlorites.

66. The process of claim 65 wherein said oxidizing agent is sodium hypochlorite.

67. The process of claim 50 wherein said agitation step is followed by the step of neutralizing said dispersion to a pH from about 5 to about 7.

68. The process of claim 50 wherein said agitation step is followed by the step of neutralizing said dispersion to a pH of about 6.

69. The process of claim 50 wherein said agitation step is followed by the step of recovering said rapidly-hydratable resistant starch from said dispersion.

70. The process of claim 50 wherein said agitation step is followed by the following steps:
removing inorganic salts by washing said rapidly-hydratable resistant starch; and
gelatinizing said rapidly-hydratable resistant starch in an aqueous system.

71. The process of claim 70 wherein said gelatinizing step is carried out in excess water at a temperature from about 25° C. to about 150° C.

72. The process of claim 70 wherein said gelatinizing step is carried out in excess water at a temperature from about 40° C. to about 95° C.

73. The process of claim 50 wherein said agitation step is followed by the step of recovering said rapidly-hydratable resistant starch from said dispersion.

74. The process of claim 50 wherein said agitation step is followed by the following steps:
recovering said rapidly-hydratable resistant starch from said dispersion; and
drying said rapidly-hydratable resistant starch.

75. The process of claim 74 wherein said drying step is carried out by spray drying.

76. A process for preparing a rapidly-hydratable resistant starch, said process comprising the following steps:
preparing an aqueous dispersion of at least one cross-linked resistant starch;
mixing said dispersion at a temperature from about 10° C. to about 808° C.;
adding an oxidizing agent to the dispersion in an amount from about 0.1% to about 50% by weight (based on total weight of the starch taken as 50% by weight) at a pH from about 7 to about 12; and
agitating said dispersion for a period ranging from about 1 to about 24 hours.

77. The process of claim 76 wherein said mixing step is carried out at a pH from about 7 to about 12.

78. The process of claim 76 wherein said mixing step is carried out at a pH from about 10 to about 11.

79. The process of claim 76 wherein agitation during said agitation step is continuous throughout said agitation step.

80. The process of claim 76 wherein said oxidizing agent selected from the group consisting of periodate, chromic acid, permanganate, nitrogen dioxide, and alkali metal hypochlorites.

81. The process of claim 80 wherein said oxidizing agent is a sodium hypochlorite.

82. The process of claim 76 wherein said agitation step is followed by the step of neutralizing said dispersion to a pH from about 5 to about 7.

83. The process of claim 76 wherein said agitation step is followed by the step of neutralizing said dispersion to a pH of about 6.

84. The process of claim 76 wherein said agitation step is followed by the step of recovering said rapidly-hydratable resistant starch from said dispersion.

85. The process of claim 76 wherein said agitation step is followed by the following steps:
removing inorganic salts by washing said rapidly-hydratable resistant starch; and
gelatinizing said rapidly-hydratable resistant starch in an aqueous system.

86. The process of claim 85 wherein said gelatinizing step is carried out in excess water at a temperature from about 25° C. to about 150° C.

87. The process of claim 85 wherein said gelatinizing step is carried out in excess water at a temperature from about 40° C. to about 95° C.

88. The process of claim 76 wherein said agitation step is followed by the step of recovering said rapidly-hydratable resistant starch from said dispersion.

89. The process of claim 76 wherein said agitation step is followed by the following steps:
recovering said rapidly-hydratable resistant starch from said dispersion; and
drying said rapidly-hydratable resistant starch.

90. The process of claim 89 wherein said drying step is carried out by spray drying.
